(19) United States
(12) Patent Application Publication
(10) Pub. No.: US 2019/0019215 A1
(43) Pub. Date: Jan. 17, 2019

(54) DETERMINING EFFECTS OF PRESENTING A CONTENT ITEM TO VARIOUS USERS ON A LIKELIHOOD OF ANOTHER USER PERFORMING A SPECIFIC ACTION ASSOCIATED WITH THE CONTENT ITEM

(71) Applicant: Facebook, Inc., Menlo Park, CA (US)

(72) Inventors: Erjie Ang, Sunnyvale, CA (US); Aleksey Sergeyevich Fadeev, Seattle, WA (US)

(21) Appl. No.: 15/650,635

(22) Filed: Jul. 14, 2017

(51) Int. Cl. G06Q 30/02; G06F 17/30; G06Q 30/06

(52) U.S. Cl. CPC G06Q 30/0251; G06F 17/30; G06Q 10/00; G06Q 30/0601; G06Q 30/02

(57) ABSTRACT

An online system determines a metric indicating whether presenting a content item to various users increased a likelihood of other users performing a specific action associated with the content item. To determine the metric, the online system identifies a control set of users who are not presented with the content item and determines measures of affinity for users of the control set with other users of the control set and for users to whom the content item was presented. Based on measures of affinity for users of the control set and for users who were presented with the content item, the online system identifies segments of users of the control set having different measures of affinity for users of the control set and for users presented with the content item. The online system determines the metric bases on occurrences of the specific action by users in different segments.

### BACKGROUND

This disclosure relates generally to presenting content to users of an online system, and more specifically to the determining an effect of presenting a content item to users on actions performed by other users online system.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. An online system may also generate content for presentation to a user, such as content describing actions taken by other users on the online system.

Additionally, many online systems commonly allow publishing users (e.g., businesses) to sponsor presentation of content on an online system to gain public attention for a user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the publishing user. Frequently, online systems charge a publishing user for each presentation of sponsored content to an online system user or for each interaction with sponsored content by an online system user. For example, an online system receives compensation from a publishing user each time a content item provided by the publishing user is displayed to another user on the online system or each time another user is presented with a content item on the online system and interacts with the content item (e.g., selects a link included in the content item), or each time another user performs another action after being presented with the content item.

Publishing users providing content items to an online system for presentation often evaluate effectiveness of presenting a content item via the online system based on differences between actions taken by users to whom the content item was presented during a time interval and actions taken by other users to whom the content item was not presented during the time interval. However, presentation of a content item to a user of an online system may also affect actions performed by other online system users connected to the user to whom the content item was presented. This effect on actions by users other than users to whom a content item is presented may influence how a publishing user evaluates performance of presentation of the content item via the online system. Similarly, how presenting content items to a user affects actions by other users connected to the user may impact how publishing users, or how an online system, selects users to be presented with content items received from a publishing user.

### SUMMARY

An online system presents various content items to its users. In various embodiments, the online system receives a content item from a publishing user for presentation to other users of the online system. The received content item is associated with a specific action that the publishing user desires users to perform after being presented with the content item. For example, the content item includes an objective specifying the specific action that the publishing user desires other users to perform when presented with content included in the content item. Example objectives include: installing an application associated with the content item, indicating a preference for the content item, sharing a content item with other users, interacting with an object associated with a content item, purchasing an item via an application associated with the content item, or performing any other suitable action.

When presenting content to users, the online system identifies a control set of users who are not eligible to be presented with the content item. For example, the online system determines a specific percentage of users or receives the specific percentage of users from the publishing user, and identifies the control set of users as a product of the specific percentage and a number of users eligible to be presented with the content item. In various embodiments, the online system identifies the control set when presenting content to various users by withholding the content item from one or more selection processes selecting content for presentation to various users so the content item is not presented to the control set of users. The online system stores information identifying users in the control set; for example, the online system stores indications associated with various users for whom the content item was withheld from selection processes selection content for presentation.

As the online system identifies opportunities to present content to users of the online system who are not included in the control set, the online system includes the content item in selection processes that select content for presentation to various users who are not included in the control set. A selection process selects content items for presentation to a user based on measures of relevance of the content items to the user, and may account for bid amounts included in various content items when selecting content items for presentation to the user. Hence, the online system presents the content item to a subset of the users of the online system who are not included in the control set via identified opportunities where the one or more selection process selected the content item for presentation. However, the one or more selection processes may not select the content item for presentation to certain users via identified opportunities, so the content item may not be presented to various users who are not in the control set, even though the users not in the control set are eligible to be presented with the content item.

After presenting the content item to at least the subset of the online system users who are not included in the control set, for each user in a group within the control set, the online system determines measures of affinity of a user of the group for each of a plurality of users of the control set and determines measures of affinity of the user of the group for each of a plurality of users who are not included in the control set. The online system may retrieve a measure of affinity of the user of the group for each of the plurality of users of the control set and retrieves a measure of affinity of the user for the group for each of the plurality of users who are not included in the control set. Alternatively, for a user of the group, the online system ranks users of the control set based on stored affinities of the user of the group for users of the control set and similarly ranks users who are not included in the control set based on stored affinities of the user of the group for users who are not included in the control set. The online system determines measures of affinity of the user of the group for a user of the control set based on a position of the user of the control set in the ranking; for example, the measure of affinity of the user of the group for the user of the control set is based on a ratio of the position of the user of the control set to a number of users in the control set included in the ranking (e.g., the ratio of the position of the user of the control set to a number of users in the control set included in the ranking subtracted from a constant). Similarly, the online system determines measures of affinity of the user of the group for a user who is not included in the control set based on a position of the user who is not in the control set in the ranking; for example, the measure of affinity of the user of the group for the user who is not included in the control set is based on a ratio of the position of the user who Is not included in the control set to a number of users who are not included in the control set included in the ranking (e.g., the ratio of the position of the user of the user who is not in the control set to a number of users who are not in the control set included in the ranking subtracted from a constant).

Based on the measures of affinity of the user of the group for each of the plurality of users of the control set, the online system identifies segments that each include users of the group. In one embodiment, a segment identified by the online system includes users of the group having a measure of affinity for users of the control set within a particular range and having a measure of affinity for users who are not included in the control set within a specific range. Hence, a segment includes users of the group having the particular range of measures of affinity for users of the control set and having the specific range of measures of affinity for users who are not included in the control set. The online system may identify any suitable number of segments (e.g., ten) in various embodiments, and may use any suitable ranges of measures of affinity for users of the control set and measures of affinity for users who are not included in the control set when identifying the segments of users of the group. Hence, each segment includes users of the control set having different measures of affinity for users of the control set and different measures of affinity for users who are not included in the control set.

Based on actions associated with users of the segment, the online system determines a rate at which users of the segment performed the specific action associated with the content item. In various embodiments, the segment includes users of the group having greater than a minimum measure of affinity for users of the control set. The segment includes users having greater than the minimum measures of affinity for users of the control set and having less than a maximum measure of affinity for users who are not included in the control set in various embodiments. The online system determines a number of occurrences of the specific action by users of the segment based on information identifying actions performed by users of the online system and determines the rate as a ratio of the number of occurrences of the specific action associated with the content item by users of the segment to a number of users in the segment.

Similarly, the online system determines an additional rate based on occurrences of the specific action by users of an additional segment based on information maintained by the online system identifying actions performed by users. The additional rate identifies occurrences of the specific action by users of the additional segment, which includes users of the control set having different measures of affinity for users of the control set than the users included in the segment. In various embodiments, the additional segment includes users of the group having greater than the minimum measure of affinity for users who are not included in the control set. The additional segment includes users having greater than the minimum measure of affinity for users who are not included in the control set and having less than the maximum measure of affinity for users of the control set in various embodiments. The online system determines a number of occurrences of the specific action by users of the additional segment based on information identifying actions performed by users of the online system and determines the rate as a ratio of the number of occurrences of the specific action associated with the content item by users of the additional segment to a number of users in the additional segment.

By comparing the rate and the additional rate, the online system generates a metric describing an effect of presenting resenting the content item to users for whom another user has at least a threshold measure of affinity on a likelihood of the other user performing the specific action. Hence, the metric allows the online system to represent how presenting the content item to users affects likelihoods of other users performing the specific action, while accounting for the measures of affinity of the other users for the users to whom the content item was presented. For example, the online system generates a value for the metric indicating that presenting the content item to users for whom a user of the control set has at least a threshold measure of affinity increases the likelihood of the user of the control set performing the specific action in response to the additional rate exceeding the rate; in some embodiment, the online system generates the value for the metric indicating presentation of the content item to other users for whom the user of the control set has at least the threshold measure of affinity increases the likelihood of the user of the control set performing the specific action if the additional rate exceeds the rate by at least a threshold amount. Conversely, if the additional rate is less than the rate, the online system may generate a value for the metric indicating presentation of the content item to other users for whom the user of the control set has at least the threshold measure of affinity does not affect the likelihood of the user of the control set performing the specific action. The online system stores the value for the metric in association with the content item in various embodiments.

In other embodiments, the online system determines a difference between the additional rate and the rate and generates a value for the metric based on the difference. For example, the online system generates a value for the metric indicating presentation of the content item to other users for whom the user of the control set has at least the threshold measure of affinity increases the likelihood of the user of the control set performing the specific action if the difference between the additional rate and the rate exceeds a threshold amount. Alternatively, if the difference between the additional rate and the rate does not exceed the threshold amount, the online system generates a value for the metric that indicates presentation of the content item to other users for whom the user of the control set has at least the threshold measure of affinity does not affect the likelihood of the user of the control set performing the specific action.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment of.

FIG. 3 is a flowchart of a method for determining how presentation of a content item to users affects likelihoods of other users performing a specific action associated with the content item, in accordance with an embodiment.

FIG. 4 is an example diagram showing identification of segments of users who were not presented with a content item based on measures of affinity of the users for other users, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

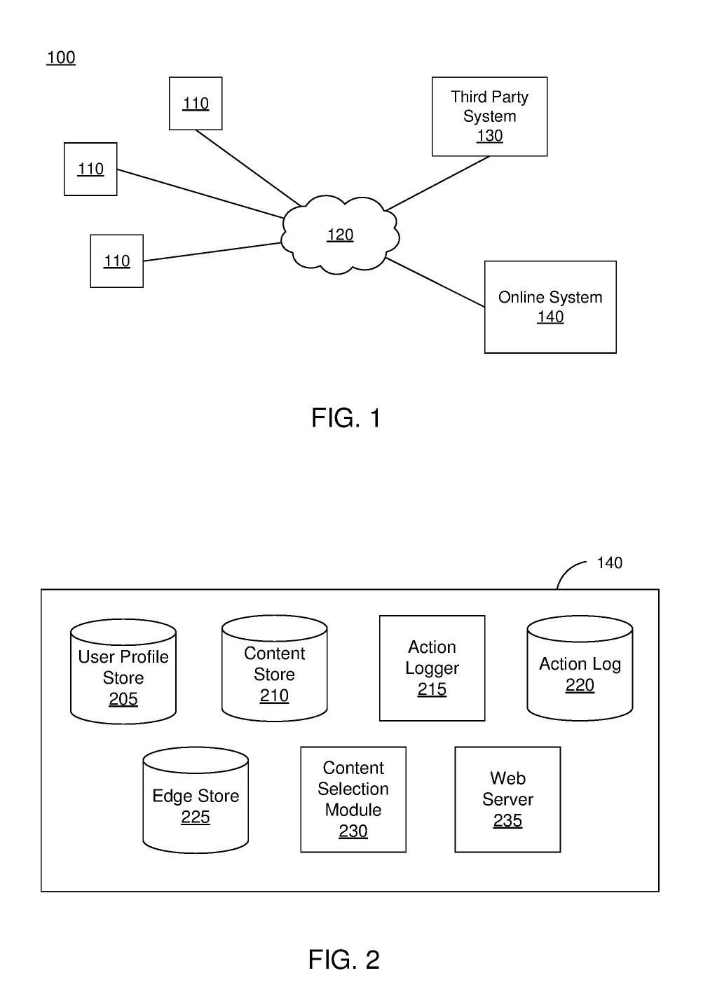

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

Various third party systems 130 provide content to users of the online system 140. For example, a third party system 130 maintains pages of content that users of the online system 140 may access through one or more applications executing on a client device 110. The third party system 130 may provide content items to the online system 140 identifying content provided by the online system 130 to notify users of the online system 140 of the content provided by the third party system 130. For example, a content item provided by the third party system 130 to the online system 140 identifies a page of content provided by the online system 140 that specifies a network address for obtaining the page of content. If the online system 140 presents the content item to a user who subsequently accesses the content item via a client device 110, the client device 110 obtains the page of content from the network address specified in the content item. This allows the user to more easily access the page of content.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image, with information identifying the images in which a user is tagged stored in the user profile of the user. A user profile in the user profile store 205 may also maintain references to actions by the corresponding user performed on content items in the content store 210 and stored in the action log 220.

Each user profile includes user identifying information allowing the online system 140 to uniquely identify users corresponding to different user profiles. For example, each user profile includes an electronic mail (“email”) address, allowing the online system 140 to identify different users based on their email addresses. However, a user profile may include any suitable user identifying information associated with users by the online system 140 that allows the online system 140 to identify different users.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction (or a specific action) that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In various embodiments, the content store 210 includes multiple campaigns, which each include one or more content items. In various embodiments, a campaign in associated with one or more characteristics that are attributed to each content item of the campaign. For example, a bid amount associated with a campaign is associated with each content item of the campaign. Similarly, an objective associated with a campaign is associated with each content item of the campaign. In various embodiments, a user providing content items to the online system 140 provides the online system 140 with various campaigns each including content items having different characteristics (e.g., associated with different content, including different types of content for presentation), and the campaigns are stored in the content store 210 for subsequent retrieval by the content selection module 230, which is further described below.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with ad requests when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the ad request's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items, such as stories describing actions associated with other online system users connected to the user, which are not associated with bid amounts. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

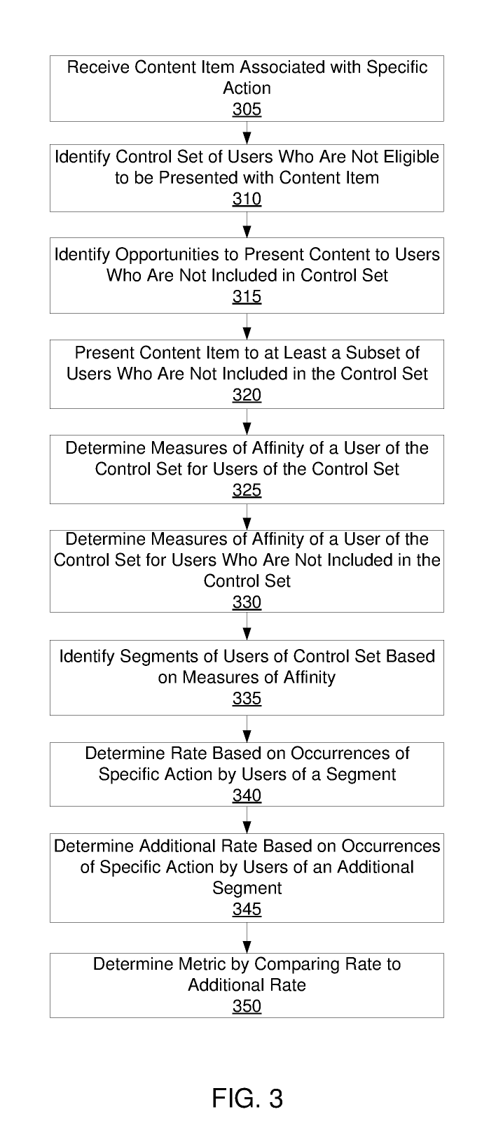

As further described below in conjunction with FIG. 3, the content selection module 230 evaluates an effect of presenting a content item associated with a specific action to various users on likelihoods of other users having at least a threshold measure of affinity to users to whom the content item was presented performing the specific action. In various embodiments, the online system 140 determines a metric for a target user who was not presented with the content item that indicates whether presenting the content item associated with the specific action to other users to whom the target user has at least a threshold measure of affinity increases a likelihood of the target user performing the specific action. As further described below in conjunction with FIG. 3, when presenting the content item to users, the content selection module 230 identifies a control set of users who are ineligible to be presented with the content item; the target user is included in the control set. However, when the content selection module 230 identifies opportunities to present content to users who are not in the control set, the content selection module 230 includes the content item in one or more selection processes, as further described above, selecting content items for presentation to a user who is not in the control set via an identified opportunity. Hence, the content item is presented to a subset of the users who are not in the control set via the identified opportunities.

After presenting the content item to various users who are not in the control set, the content selection module 230, for the target user of the control set, the content selection module 230 determines measures of affinity of the target user for each of multiple users of the control set and measures of affinity of the target user for each of multiple users who are not included in the control set. In various embodiments, the content selection module 230 retrieves measures of affinity of the target user for various users who are included in the control set and who are not included in the control set from the edge store 225. From the determined measures of affinity, the content selection module 230 identifies segments of users of the control set. For example, the content selection module 230 identifies segments of users of the control set that each include users having measures of affinity for users of the control set within a range and having measures of affinity for users who are not in the control set within the range. As further described below in conjunction with FIG. 3, the content selection module 230 compares rates of occurrence of the specific action for different segments to determine the metric indicating whether presentation of the content item to other users increases a likelihood of another user performing the specific action.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or BlackberryOS.

### Determining Effects of Presenting a Content Item to Users on Likelihoods of Other Users Performing an Action

FIG. 3 is a flowchart of one embodiment of a method for determining how presentation of a content item to users affects likelihoods of other users performing a specific action associated with the content item. In other embodiments, the method may include different and/or additional steps than those shown in FIG. 3. Additionally, steps of the method may be performed in different orders than the order described in conjunction with FIG. 3 in various embodiments.

The online system 140 receives 305 a content item from a publishing user for presentation to other users of the online system 140. The received content item is associated with a specific action that the publishing user desires users to perform after being presented with the content item. As further described above in conjunction with FIG. 3, the content item includes an objective specifying the specific action that the publishing user desires other users to perform when presented with content included in the content item. Example objectives include: installing an application associated with the content item, indicating a preference for the content item, sharing a content item with other users, interacting with an object associated with a content item, purchasing an item via an application associated with the content item, or performing any other suitable action. Additionally, the content item may be associated with a bid amount specifying an amount of compensation the online system 140 receives from the publishing user in exchange for other online system users performing the specific action associated with the content item, as further described above in conjunction with FIG. 2, in various embodiments.

When presenting content to users, the online system 140 identifies 310 a control set of users who are not eligible to be presented with the content item. For example, the online system 140 determines a specific percentage of users or receives the specific percentage of users from the publishing user, and identifies 310 the control set of users as a product of the specific percentage and a number of users eligible to be presented with the content item. In various embodiments, the online system 140 identifies the control set 310 when presenting content to various users by withholding the content item from one or more selection processes selecting content for presentation to various users so the content item is not presented to the control set of users. The online system 140 stores information identifying users in the control set; for example, the online system 140 stores indications associated with various users for whom the content item was withheld from selection processes selection content for presentation.

However, as the online system 140 identifies 315 opportunities to present content to users of the online system 140 who are not included in the control set, the online system includes the content item in selection processes that select content for presentation to various users who are not included in the control set. As further described above in conjunction with FIG. 2, a selection process selects content items for presentation to a user based on measures of relevance of the content items to the user, and may account for bid amounts included in various content items when selecting content items for presentation to the user. Hence, the online system 140 presents 320 the content item to a subset of the users of the online system 140 who are not included in the control set via identified opportunities where the one or more selection process selected the content item for presentation. However, the one or more selection processes may not select the content item for presentation to certain users via identified opportunities, so the content item may not be presented 320 to various users who are not in the control set, even though the users not in the control set are eligible to be presented with the content item.

After presenting 320 the content item to at least the subset of the online system users who are not included in the control set, for each user in a group within the control set, the online system 140 determines 325 measures of affinity of the user of the group for each of a plurality of users of the control set. In various embodiments, the online system 140 retrieves a measure of affinity of the user of the group for each of the plurality of users of the control set and retrieves a measure of affinity of the user for the group for each of the plurality of users who are not included in the control set. Alternatively, for a user of the group, the online system 140 ranks users of the control set based on affinities of the user of the group for users of the control set based on information in the edge store 225 and similarly ranks users who are not included in the control set based on affinities of the user of the group for users who are not included in the control set based on information in the edge store 225. The online system 140 determines 325 measures of affinity of the user of the group for a user of the control set based on a position of the user of the control set in the ranking; for example, the measure of affinity of the user of the group for the user of the control set is based on a ratio of the position of the user of the control set to a number of users in the control set included in the ranking (e.g., the ratio of the position of the user of the control set to a number of users in the control set included in the ranking subtracted from a constant). Similarly, the online system 140 determines 330 measures of affinity of the user of the group for a user who is not included in the control set based on a position of the user who is not in the control set in the ranking; for example, the measure of affinity of the user of the group for the user who is not included in the control set is based on a ratio of the position of the user who Is not included in the control set to a number of users who are not included in the control set included in the ranking (e.g., the ratio of the position of the user of the user who is not in the control set to a number of users who are not in the control set included in the ranking subtracted from a constant).

Based on the measures of affinity of the user of the group for each of the plurality of users of the control set, the online system 140 identifies 335 segments that each include users of the group. In one embodiment, a segment identified 335 by the online system 140 includes users of the group having a measure of affinity for users of the control set within a particular range and having a measure of affinity for users who are not included in the control set within a specific range. Hence, a segment includes users of the group having the particular range of measures of affinity for users of the control set and having the specific range of measures of affinity for users who are not included in the control set. The online system 140 may identify 335 any suitable number of segments (e.g., ten) in various embodiments, and may use any suitable ranges of measures of affinity for users of the control set and measures of affinity for users who are not included in the control set when identifying 335 the segments of users of the group. Hence, each segment includes user of the control set having different measures of affinity for users of the control set and different measures of affinity for users who are not included in the control set.

The online system 140 retrieves actions associated with the users included in a segment and in an additional segment. Based on retrieved actions associated with users of the segment, the online system 140 determines 340 a rate at which users of the segment performed the specific action associated with the content item. In various embodiments, the segment includes users of the group having greater than a minimum measure of affinity for users of the control set. The segment includes users having greater than the minimum measures of affinity for users of the control set and having less than a maximum measure of affinity for users who are not included in the control set in various embodiments. The online system 140 determines a number of occurrences of the specific action by users of the segment based on information identifying actions performed by users of the online system 140 and determines the rate as a ratio of the number of occurrences of the specific action associated with the content item by users of the segment to a number of users in the segment.

Similarly, the online system 140 determines 345 an additional rate based on occurrences of the specific action by users of an additional segment based on information maintained by the online system 140 identifying actions performed by users. The additional rate identifies occurrences of the specific action by users of the additional segment, which includes users of the control set having different measures of affinity for users of the control set than the users included in the segment. In various embodiments, the additional segment includes users of the group having greater than the minimum measure of affinity for users who are not included in the control set. The additional segment includes users having greater than the minimum measure of affinity for users who are not included in the control set and having less than the maximum measure of affinity for users of the control set in various embodiments. The online system 140 determines a number of occurrences of the specific action by users of the additional segment based on information identifying actions performed by users of the online system 140 and determines the rate as a ratio of the number of occurrences of the specific action associated with the content item by users of the additional segment to a number of users in the additional segment.

By comparing the rate and the additional rate, the online system 140 generating 350 a metric describing an effect of presenting resenting the content item to users for whom another user has at least a threshold measure of affinity on a likelihood of the other user performing the specific action. Hence, the metric allows the online system 140 to represent how presenting the content item to users affects likelihoods of other users performing the specific action, while accounting for the measures of affinity of the other users for the users to whom the content item was presented. For example, the online system 140 generates 350 a value for the metric indicating that presenting the content item to users for whom a user of the control set has at least a threshold measure of affinity increases the likelihood of the user of the control set performing the specific action in response to the additional rate exceeding the rate; in some embodiment, the online system 140 generates 350 the value for the metric indicating presentation of the content item to other users for whom the user of the control set has at least the threshold measure of affinity increases the likelihood of the user of the control set performing the specific action if the additional rate exceeds the rate by at least a threshold amount. Conversely, if the additional rate is less than the rate, the online system 140 may generate 350 a value for the metric indicating presentation of the content item to other users for whom the user of the control set has at least the threshold measure of affinity does not affect the likelihood of the user of the control set performing the specific action. The online system 140 stores the value for the metric in association with the content item in various embodiments.

In other embodiments, the online system 140 determines a difference between the additional rate and the rate and generates 350 a value for the metric based on the difference. For example, the online system 140 generates 350 a value for the metric indicating presentation of the content item to other users for whom the user of the control set has at least the threshold measure of affinity increases the likelihood of the user of the control set performing the specific action if the difference between the additional rate and the rate exceeds a threshold amount. Alternatively, if the difference between the additional rate and the rate does not exceed the threshold amount, the online system 140 generates 350 a value for the metric that indicates presentation of the content item to other users for whom the user of the control set has at least the threshold measure of affinity does not affect the likelihood of the user of the control set performing the specific action.

If a value for the metric determined 350 indicates presentation of the content item to other users for whom the user of the control set has at least the threshold measure of affinity, the online system 140 may identify users of the control set as eligible to be presented with the content item. Subsequently, if the online system 140 identifies an opportunity to present content to users of the control set, the online system 140 includes the content item in one or more selection processes selecting content for presentation to the users of the control set. This increases a likelihood of the online system 140 presenting the content item to users who are likely to perform the specific action associated with the content item. In various embodiments, the online system 140 provides the publishing user with information describing the generated metric, allowing the publishing user to evaluate how presenting the content item to users affects a likelihood of other users having at least a threshold measure of affinity performing the specific action associated with the content item.

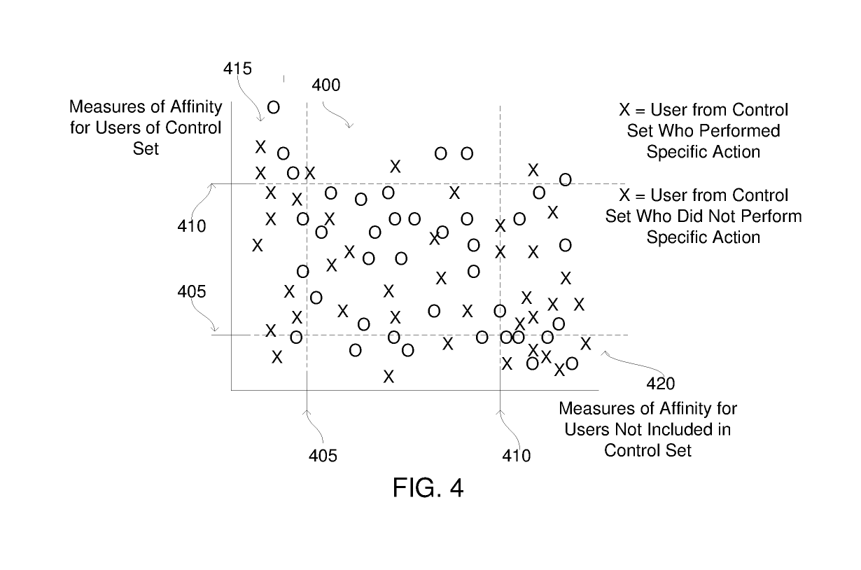

FIG. 4 is an example diagram showing identification of segments of the control set based on measures of affinity of users of the control set for other users. In the example of FIG. 4, different users of the control set are identified based on their measures of affinity for users of the control set and measures of affinity for users who are not included in the control set. FIG. 4 shows measures of affinity of users of the control set for other users of the control set along a vertical axis and measures of affinity of users of the control set for users who are not included in the control set along a horizontal axis. Different users of the control set are identified by an “X” or an “0” in FIG. 4 at positions corresponding to a measure of affinity of the user of the control set for other users of the control set and to a measure of affinity of the user of the control set for users who are not included in the control set. In FIG. 4, an “X” identifies a user of the control set who performed a specific action associated with a content item presented to various users who are not included in the control set, while an “0” identifies a user of the control set who did not perform the specific action.

In the example of FIG. 4, the online system 140 identifies segments of users of the control set based on a maximum measure of affinity 405 and a minimum measure of affinity 410. For example, the online system 140 identifies a segment 415 including users of the control set having less than the maximum measure of affinity 405 for users who are not included in the control set and having greater than the minimum measure of affinity 410 for users of the control set. Additionally, in the example of FIG. 4, the online system 140 identifies an additional segment 420 including users of the control set having less than the maximum measure of affinity 405 for users of the control set and having greater than the minimum measure of affinity 410 for users who are not included in the control set. As further described above in conjunction with FIG. 3, the online system 140 identifies a number of occurrences of the specific action by users of the segment 415 and by users of the additional segment 420 and generates a metric describing an effect of presenting the content item to various users affecting a likelihood of another user having at least a threshold measure of affinity to the users to whom the content item was presented performing the specific action associated with the content item.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving a content item at an online system from a publishing user, the content item associated with a specific action to be performed by users to whom the content item was presented;
identifying a control set of users to the online system who are not eligible to be presented with the content item;
identifying opportunities to present content to users of the online system who are not included in the control set;
presenting the content item to a subset of the users of the online system who are not included in the control set via one or more of the identified opportunities;
for each of at least a group of users of the control set:
determining measures of affinity of a user of the group for each of a plurality of users of the control set, and
determining measures of affinity of the user of the group for each of a plurality of users who are not included in the control set;
identifying segments of the group of users of the control set, each segment based on the measures of affinity of users of the group for each of the plurality of users of the control set and based on the measures of affinity of the user of the group for each of the plurality of users who are not included in the control set;
determining a rate at which users of a segment including users of the group having greater than a minimum measure of affinity for users who are not included in the control set performed the specific action;
determining an additional rate at which users of an additional segment including users of the group having less than a maximum measures of affinity for users who are not included in the control set performed the specific action; and
generating a metric based on a comparison of the rate and the additional rate, the metric indicating a likelihood of presenting the content item one or more users affecting a likelihood another user having at least a threshold measure of affinity for the one or more users performing the specific action.

2. The method of claim 1, wherein determining measures of affinity of the user of the group for each of a plurality of users of the control set comprises:
ranking the plurality of users of the control set based on the measures of affinity of the user of the group for each of the plurality of users of the control set; and
determining a measure of affinity of the user of the group for a user of the control set based on a position of the user of the control set in the ranking.

3. The method of claim 2, wherein determining the measure of affinity of the user of the group for the user of the control set based on a position of the user of the control set in the ranking comprises:
determining a ratio of the position of the user of the control set in the ranking to a number of users of the control set included in the ranking; and
determining the measure of affinity of the user of the group for the user of the control set by subtracting the ratio from a constant.

4. The method of claim 2, wherein determining measures of affinity of the user of the group for each of a plurality of users who are not included in the control set comprises:
generating an additional ranking of the plurality of users who are not included in the control set based on the measures of affinity of the user of the group for each of the plurality of users who are not included in the control set; and
determining a measure of affinity of the user of the group for a user who is not included in the control set based on a position of the user who is not included in the control set in the additional ranking.

5. The method of claim 4, wherein determining the measure of affinity of the user of the group for the user who is not included in the control set based on the position of the user who is not included in the control set in the additional ranking comprises:
determining a ratio of the position of the user who is not included in the control set in the additional ranking to a number of users who are not included in the control set included in the additional ranking; and
determining the measure of affinity of the user of the group for the user of the control set by subtracting the ratio from a constant.

6. The method of claim 1, wherein determining the rate at which users of a segment including users of the group having greater than a minimum measure of affinity for users who are not included in the control set performed the specific action comprises:
determining a number of occurrences of the specific action by users of the group having greater than the minimum measure of affinity for users who are not included in the control set and having less than the maximum measure of affinity for users of the control set.

7. The method of claim 6, wherein determining the additional rate at which users of an additional segment including users of the group having less than the maximum measure of affinity for users who are not included in the control set performed the specific action comprises:
determining an additional number of occurrences of the specific action by users of the group having greater than the minimum measure of affinity for users of the control set and having less than the maximum measure of affinity for users who are not included in the control set.

8. The method of claim 1, wherein generating the metric based on the comparison of the rate and the additional rate comprises:
generating a value for the metric indicating presenting the content item one or more users increases the likelihood another user having at least the threshold measure of affinity for the one or more users performing the specific action in response to the additional rate exceeding the rate.

9. The method of claim 1, wherein generating the metric based on the comparison of the rate and the additional rate comprises:
generating a value for the metric indicating presenting the content item one or more users increases the likelihood another user having at least the threshold measure of affinity for the one or more users performing the specific action in response to the a difference between the additional rate and the rate exceeding a threshold amount.

10. The method of claim 1, further comprising:
identifying users of the control set as eligible to be presented with the content item in response to the metric indicating presenting the content item one or more users increases the likelihood another user having at least the threshold measure of affinity for the one or more users performing the specific action.

11. A computer program product comprising a computer readable storage medium having instructions encoded thereon that, when executed by a processor, cause the processor to:
receive a content item at an online system from a publishing user, the content item associated with a specific action to be performed by users to whom the content item was presented;
identify a control set of users to the online system who are not eligible to be presented with the content item;
identify opportunities to present content to users of the online system who are not included in the control set;
present the content item to a subset of the users of the online system who are not included in the control set via one or more of the identified opportunities;
for each of at least a group of users of the control set:
determine measures of affinity of a user of the group for each of a plurality of users of the control set, and
determine measures of affinity of the user of the group for each of a plurality of users who are not included in the control set;
identify segments of the group of users of the control set, each segment based on the measures of affinity of users of the group for each of the plurality of users of the control set and based on the measures of affinity of the user of the group for each of the plurality of users who are not included in the control set;
determine a rate at which users of a segment including users of the group having greater than a minimum measure of affinity for users who are not included in the control set performed the specific action;
determine an additional rate at which users of an additional segment including users of the group having less than a maximum measures of affinity for users who are not included in the control set performed the specific action; and
generate a metric based on a comparison of the rate and the additional rate, the metric indicating a likelihood of presenting the content item one or more users affecting a likelihood another user having at least a threshold measure of affinity for the one or more users performing the specific action.

12. The computer program product of claim 11, wherein determine measures of affinity of the user of the group for each of a plurality of users of the control set comprises:
rank the plurality of users of the control set based on the measures of affinity of the user of the group for each of the plurality of users of the control set; and
determine a measure of affinity of the user of the group for a user of the control set based on a position of the user of the control set in the ranking.

13. The computer program product of claim 12, wherein determine the measure of affinity of the user of the group for the user of the control set based on a position of the user of the control set in the ranking comprises:
determine a ratio of the position of the user of the control set in the ranking to a number of users of the control set included in the ranking; and
determine the measure of affinity of the user of the group for the user of the control set by subtracting the ratio from a constant.

14. The computer program product of claim 12, wherein determine measures of affinity of the user of the group for each of a plurality of users who are not included in the control set comprises:
generate an additional ranking of the plurality of users who are not included in the control set based on the measures of affinity of the user of the group for each of the plurality of users who are not included in the control set; and
determine a measure of affinity of the user of the group for a user who is not included in the control set based on a position of the user who is not included in the control set in the additional ranking.

15. The computer program product of claim 14, wherein determine the measure of affinity of the user of the group for the user who is not included in the control set based on the position of the user who is not included in the control set in the additional ranking comprises:
determine a ratio of the position of the user who is not included in the control set in the additional ranking to a number of users who are not included in the control set included in the additional ranking; and
determine the measure of affinity of the user of the group for the user of the control set by subtracting the ratio from a constant.

16. The computer program product of claim 11, wherein determine the rate at which users of a segment including users of the group having greater than a minimum measure of affinity for users who are not included in the control set performed the specific action comprises:
determine a number of occurrences of the specific action by users of the group having greater than the minimum measure of affinity for users who are not included in the control set and having less than the maximum measure of affinity for users of the control set.

17. The computer program product of claim 16, wherein determine the additional rate at which users of an additional segment including users of the group having less than the maximum measure of affinity for users who are not included in the control set performed the specific action comprises:
determine an additional number of occurrences of the specific action by users of the group having greater than the minimum measure of affinity for users of the control set and having less than the maximum measure of affinity for users who are not included in the control set.

18. The computer program product of claim 11, wherein generate the metric based on the comparison of the rate and the additional rate comprises:
generate a value for the metric indicating presenting the content item one or more users increases the likelihood another user having at least the threshold measure of affinity for the one or more users performing the specific action in response to the additional rate exceeding the rate.

19. The computer program product of claim 11, wherein generate the metric based on the comparison of the rate and the additional rate comprises:
generate a value for the metric indicating presenting the content item one or more users increases the likelihood another user having at least the threshold measure of affinity for the one or more users performing the specific action in response to the a difference between the additional rate and the rate exceeding a threshold amount.

20. The computer program product of claim 11, wherein the computer readable storage medium further has instructions encoded thereon that, when executed by the processor, cause the processor to:
identify users of the control set as eligible to be presented with the content item in response to the metric indicating presenting the content item one or more users increases the likelihood another user having at least the threshold measure of affinity for the one or more users performing the specific action.
